(19) United States
(12) Patent Application Publication
(10) Pub. No.: US 2021/0092367 A1
(43) Pub. Date: Mar. 25, 2021

(54) APPARATUS AND METHOD FOR VIDEO ENCODING OR DECODING

(71) Applicant: SK TELECOM CO., LTD., Seoul (KR)

(72) Inventors: Jeong-yeon LIM, Seoul (KR); Sun-young LEE, Seoul (KR); Se-hoon SON, Seoul (KR); Jae-seob SHIN, Seoul (KR); Hyeong-duck KIM, Suwon-si Gyeonggi-do (KR); Gyeong-taek LEE, Seoul (KR)

(21) Appl. No.: 17/109,751

(22) Filed: Dec. 2, 2020

Related U.S. Application Data
(63) Continuation of application No. 16/342,608, filed on Apr. 17, 2019, now abandoned.

(30) Foreign Application Priority Data
Oct. 17, 2016 (KR) 10-2016-0134654
Jan. 9, 2017 (KR) 10-2017-0003154

(51) Int. Cl. H04N 19/11; H04N 19/70; H04N 19/176; H04N 19/597; H04N 19/105; H04N 19/167; H04N 19/593

(52) U.S. Cl. CPC H04N 19/11; H04N 19/70; H04N 19/176; H04N 19/593; H04N 19/105; H04N 19/167; H04N 19/597

(57) ABSTRACT

Disclosed herein is a method of encoding prediction information about a current block located in a first face to be encoded in encoding each face of a 2D image onto which 360 video is projected. The method includes generating prediction information candidates using neighboring blocks around the current block; and encoding a syntax element for the prediction information about the current block using the prediction information candidates. When a border of the current block coincides with a border of the first face, a block adjoining the current block based on the 360 video rather than the 2D image is set as at least a part of the neighboring blocks.

### CROSS-REFERENCE TO RELATED APPLICATIONS

This application is a continuation of U.S. patent application Ser. No. 16/342,608, filed on Apr. 17, 2019, which is a National Phase of International Application No. PCT/KR2017/011457, filed on Oct. 17, 2017, which is based upon and claims the benefit of priorities from Korean Patent Application No. 10-2016-0134654, filed on Oct. 17, 2016, and Korean Patent Application No. 10-2017-0003154, filed on Jan. 9, 2017. The disclosures of the above-listed applications are hereby incorporated by reference herein in their entirety.

### TECHNICAL FIELD

The present invention relates to video encoding or decoding for efficiently encoding video.

### BACKGROUND ART

Since video data consumes a larger amount of data than voice data or still image data, storing or transmitting video data without compression thereof requires a lot of hardware resources including memory. Accordingly, in storing or transmitting video data, the video data is compressed using an encoder so as to be stored or transmitted. Then, a decoder receives the compressed video data, and decompresses and reproduces the video data. Compression techniques for such video include H.264/AVC and High Efficiency Video Coding (HEVC), which was established in early 2013 and improved coding efficiency over H.264/AVC by about 40%.

However, as video size, resolution, and frame rate are gradually increasing, the amount of data to be encoded is also increasing. Accordingly, there is a demand for a compression technique having higher coding efficiency than conventional compression techniques.

There is also increasing demand for video content such as games or 360-degree video (hereinafter referred to as “360 video”) in addition to existing 2D natural images generated by cameras. Since such games or 360 video has features different from existing 2D natural images, accordingly conventional compression techniques based on 2D images have a limitation in compressing the games or 360 video.

360 video is images captured in various directions using a plurality of cameras. In order to compress and transmit a video of various scenes, images output from several cameras are stitched into one 2D image, and the stitched image is compressed and transmitted to a decoding apparatus. The decoding apparatus decodes the compressed image, and then the decoded image is mapped to 3D space and reproduced.

A representative projection format for 360 video is equirectangular projection as shown in FIGS. 1A and 1B. FIG. 1A shows a spherical 360 video image mapped in 3D, and FIG. 1B shows a result of projection of the spherical 360 video image onto an equirectangular format.

Such equirectangular projection has disadvantages that it excessively increases pixels in the upper and lower portions of an image, which results in severe distortion, and that it increases the amount of data and the encoding throughput of the increased portions when the image is compressed. Therefore, an image compression technique capable of efficiently encoding 360 video is required.

### DISCLOSURE

### Technical Problem

Therefore, the present invention has been made in view of the above problems, and it is one object of the present invention to provide a video encoding or decoding technique for efficiently encoding video having a high resolution or a high frame rate or 360 video.

### SUMMARY

In accordance with one aspect of the present invention, provided is a method of encoding prediction information about a current block located in a first face to be encoded in encoding each face of a 2D image onto which 360 video is projected, the method including generating prediction information candidates using neighboring blocks around the current block; and encoding a syntax element for the prediction information about the current block using the prediction information candidates, wherein, when a border of the current block coincides with a border of the first face, a block adjoining the current block based on the 360 video is set as at least a part of the neighboring blocks.

In accordance with another aspect of the present invention, provided is a method of decoding prediction information about a current block located in a first face to be decoded from 360 video encoded into a 2D image, the method including decoding a syntax element for the prediction information about the current block from a bitstream; generating prediction information candidates using neighboring blocks around the current block; and restoring the prediction information about the current block using the prediction information candidates and the decoded syntax element, wherein, when a border of the current block coincides with a border of the first face, a block adjoining the current block based on the 360 video is set as at least a part of the neighboring blocks.

In accordance with yet another aspect of the present invention, provided is an apparatus for decoding prediction information about a current block located in a first face to be decoded from 360 video encoded into a 2D image, the apparatus including a decoder configured to decode a syntax element for prediction information about the current block from a bitstream; a prediction information candidate generator configured to generate prediction information candidates using neighboring blocks around the current block; and a prediction information determinator configured to reconstruct the prediction information about the current block using the prediction information candidates and the decoded syntax element, wherein, when a border of the current block coincides with a border of the first face, the prediction information candidate generator sets a block adjoining the current block based on the 360 video as at least a part of the neighboring blocks.

### DESCRIPTION OF DRAWINGS

FIGS. 1A and 1B are an exemplary view of an equirectangular projection format of 360 video.

FIG. 2 is a block diagram of a video encoding apparatus according to an embodiment of the present invention.

FIGS. 3A and 3B are an exemplary diagram of block splitting using a Quadtree plus Binary Tree (QTBT) structure.

FIG. 4 is an exemplary diagram of a plurality of intra prediction modes.

FIG. 5 is an exemplary diagram of neighboring blocks for a current block.

FIGS. 6A to 6D are an exemplary diagram of various projection formats of 360 video.

FIGS. 7A and 7B are an exemplary diagram of the layout of a cube projection format.

FIGS. 8A and 8B are an exemplary diagram for explaining rearrangement of a layout in the cube projection format.

FIG. 9 is a block diagram of an apparatus configured to generate a syntax element for prediction information about a current block in 360 video according to an embodiment of the present invention.

FIGS. 10A and 10B are an exemplary diagram for explaining a method of determining a neighboring block of a current block in a cube format to which a compact layout is applied.

FIG. 11 is a diagram showing a detailed configuration of the intra predictor of FIG. 2 when the apparatus of FIG. 9 is applied to intra prediction.

FIGS. 12A and 12B are an exemplary diagram for explaining a method of configuring reference samples for intra prediction in a cube format.

FIGS. 13A to 13E are an exemplary diagram for explaining a method of configuring reference samples for intra prediction in various projection formats.

FIG. 14 is a diagram showing a detailed configuration of the inter predictor of FIG. 2 when the apparatus of FIG. 9 is applied to inter prediction.

FIG. 15 is a block diagram illustrating a video decoding apparatus according to an embodiment of the present invention.

FIG. 16 is a block diagram of an apparatus configured to decode prediction information about a current block in 360 video according to an embodiment of the present invention.

FIG. 17 is a diagram showing a detailed configuration of the intra predictor of FIG. 15 when the apparatus of FIG. 16 is applied to intra prediction.

FIG. 18 is a diagram showing a detailed configuration of the inter predictor of FIG. 15 when the apparatus of FIG. 16 is applied to inter prediction.

### DETAILED DESCRIPTION

Hereinafter, some embodiments of the present invention will be described in detail with reference to the accompanying drawings. It should be noted that, in adding reference numerals to the constituent elements in the respective drawings, like reference numerals designate like elements, although the elements are shown in different drawings. Further, in the following description of the present invention, a detailed description of known functions and configurations incorporated herein will be omitted when it may make the subject matter of the present invention rather unclear.

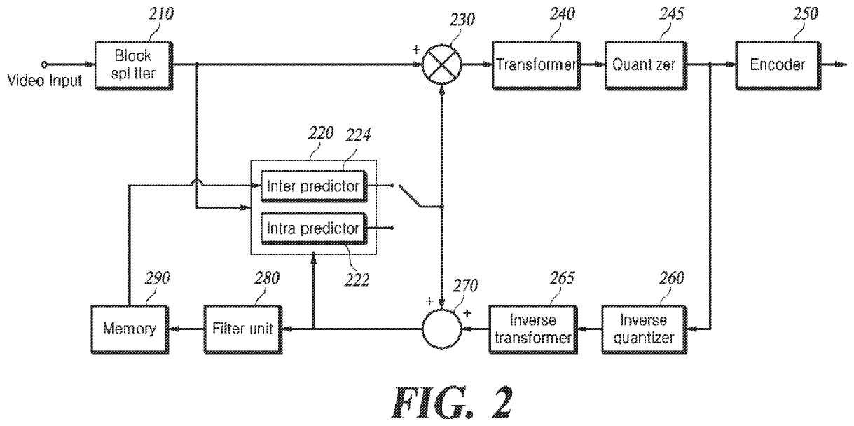

FIG. 2 is a block diagram of a video encoding apparatus according to an embodiment of the present invention.

The video encoding apparatus includes a block splitter 210, a predictor 220, a subtractor 230, a transformer 240, a quantizer 245, an encoder 250, an inverse quantizer 260, an inverse transformer 265, an adder 270, a filter unit 280, and a memory 290. Each element of the video encoding apparatus may be implemented as a hardware chip, or may be implemented as software, and the microprocessor may be implemented to execute the functions of the software corresponding to the respective elements.

The block splitter 210 splits each picture constituting video into a plurality of coding tree units (CTUs), and then recursively splits the CTUs using a tree structure. A leaf node in the tree structure is a coding unit (CU), which is a basic unit of coding. A QuadTree (QT) structure, in which a node is split into four sub-nodes, or a QuadTree plus BinaryTree (QTBT) structure combining the QT structure and a BinaryTree (BT) structure, in which a node is split into two sub-nodes, may be used as the tree structure.

In the QuadTree plus BinaryTree (QTBT) structure, a CTU can be first split according to the QT structure. Thereafter, the leaf nodes of the QT may be further split by the BT. The split information generated by the block splitter 210 by dividing the CTU by the QTBT structure is encoded by the encoder 250 and transmitted to the decoding apparatus.

In the QT, a first flag (QT_split_flag) indicating whether to split a block of a corresponding node is encoded. When the first flag is 1, the block of the node is split into four blocks of the same size. When the first flag is 0, the node is not further split by the QT.

In the BT, a second flag (BT_split_flag) indicating whether to split a block of a corresponding node is encoded. The BT may have a plurality of split types. For example, there may be a type of horizontally splitting the block of a node into two blocks of the same size and a type of vertically splitting the block of a node into two blocks of the same size. Additionally, there may be another type of asymmetrically splitting the block of a node into two blocks. The asymmetric split type may include a type of splitting the block of a node into two rectangular blocks at a ratio of 1:3, or a type of diagonally splitting the block of the node. In case where the BT has a plurality of split types as described above, the second flag indicating that the block is split is encoded, and the split type information indicating the split type of the block is additionally encoded.

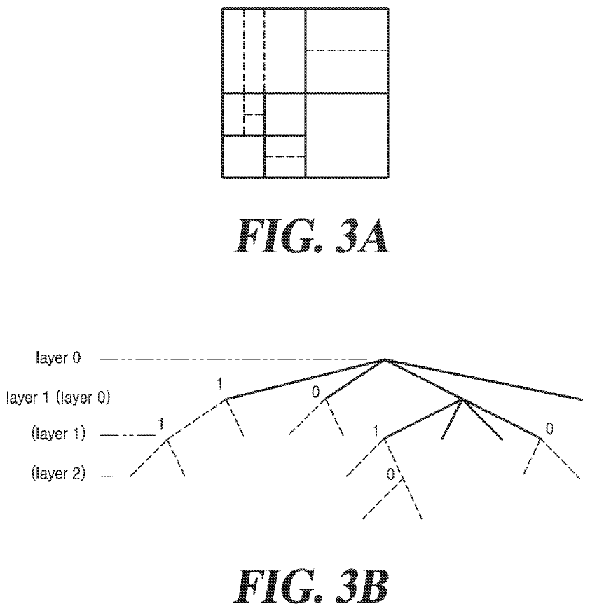

FIGS. 3A and 3B are an exemplary diagram of block splitting using a QTBT structure. FIG. 3A illustrates splitting a block by a QTBT structure, and FIG. 3B represents the splitting in a tree structure. In FIGS. 3A and 3B, the solid line represents split by the QT structure, and the dotted line represents split by the BT structure. In FIG. 3B, regarding notation of layers, a layer expression without parentheses denotes a layer of QT, and a layer expression in parentheses denotes a layer of BT. In the BT structure represented by dotted lines, the numbers are the split type information.

In FIGS. 3A and 3B, the CTU, which is the uppermost layer of QT, is split into four nodes of layer 1. Thus, the block splitter 210 generates a QT split flag (QT_split_flag=1) indicating that the CTU is split. A block corresponding to the first node of layer 1 is not split by the QT anymore. Accordingly, the block splitter 210 generates QT_split_flag=0.

Then, the block corresponding to the first node of layer 1 of QT is subjected to BT. In this embodiment, it is assumed that the BT has two split types: a type of horizontally splitting the block of a node into two blocks of the same size and a type of vertically splitting the block of a node into two blocks of the same size. The first node of layer 1 of QT becomes the root node of ‘(layer 0)’ of BT. The block corresponding to the root node of BT is further split into blocks of ‘(layer 1)’, and thus the block splitter 210 generates BT_split_flag=1 indicating that the block is split by the BT. Thereafter, the block splitter 210 generates split type information indicating whether the block is split horizontally or vertically. In FIGS. 3A and 3B, since the block corresponding to the root node of the BT is vertically split, ‘1’ indicating vertical split is generated as split type information. Among the blocks of ‘(layer 1)’ split from the root node, the first block is further split according to the vertical split type, and thus BT_split_flag=1 and the split type information ‘1’ are generated. On the other hand, the second block of (layer 1) split from the root node of the BT is not split anymore, thus BT_split_flag=0 is generated therefor.

In order to efficiently signal the information about the block splitting by the QTBT structure to the decoding apparatus, the following information may be further encoded. This information may be encoded as header information of an image into, for example, a Sequence Parameter Set (SPS) or a Picture Parameter Set (PPS).
CTU size: Block size of the uppermost layer, i.e., the root node, of the QTBT;
MinQTSize: Minimum block size of leaf nodes allowed in QT;
MaxBTSize: Maximum block size of the root node allowed in BT;
MaxBTDepth: Maximum depth allowed in BT;
MinBTSize: Minimum block size of leaf nodes allowed in BT.

In the QT, a block having the same size as MinQTSize is not further split, and thus the split information (first flag) about the QT corresponding to the block is not encoded. In addition, in the QT, a block having a size larger than MaxBTSize does not have a BT. Accordingly, the split information (second flag, split type information) about the BT corresponding to the block is not encoded. Further, when the depth of a corresponding node of BT reaches MaxBTDepth, the block of the node is not further split and the corresponding split information (second flag, split type information) about the BT of the node is not encoded. In addition, a block having the same size as MinBTSize in the BT is not further split, and the corresponding split information (second flag, split type information) about the BT is not encoded. By defining the maximum or minimum block size that a root or leaf node of QT and BT can have in a high level such as a sequence parameter set (SPS) or a picture parameter set (PPS) as described above, the amount of coding of information indicating the splitting status of the CTU and the split type may be reduced.

In an embodiment, the luma component and the chroma component of the CTU may be split using the same QTBT structure. However, the present invention is not limited thereto. The luma component and the chroma component may be split using different QTBT structures, respectively. As an example, in the case of an Intra (I) slice, the luma component and the chroma component may be split using different QTBT structures.

Hereinafter, a block corresponding to a CU to be encoded or decoded is referred to as a “current block.”

The predictor 220 generates a prediction block by predicting a current block. The predictor 220 includes an intra predictor 222 and an inter predictor 224.

The intra predictor 222 predicts pixels in the current block using pixels (reference samples) located around the current block in a current picture including the current block. There are plural intra prediction modes according to the prediction directions, and the neighboring pixels to be used and the calculation equation are defined differently according to each prediction mode.

FIG. 4 is an exemplary diagram of a plurality of intra prediction modes.

As shown in FIG. 4, the plurality of intra prediction modes may include two non-directional modes (a planar mode and a DC mode) and 65 directional modes.

The intra predictor 222 selects one intra prediction mode from among the plurality of intra prediction modes, and predicts the current block using neighboring pixels (reference samples) determined by the selected intra prediction mode and an equation corresponding to the selected intra prediction mode. The information about the selected intra prediction mode is encoded by the encoder 250 and transmitted to the decoding apparatus.

In order to efficiently encode intra prediction mode information indicating which of the plurality of intra prediction modes is used as the intra prediction mode of the current block, the intra predictor 222 selects some of the intra prediction modes that are most likely to be used as the intra prediction mode of the current block as the most probable modes (MPMs). Then, the intra predictor generates mode information indicating whether the intra prediction mode of the current block is selected from among the MPMs, and transmits the mode information to the encoder 250. When the intra prediction mode of the current block is selected from among the MPMs, the intra predictor transmits, to the encoder, first intra prediction information for indicating which mode of the MPMs is selected as the intra prediction mode of the current block. On the other hand, when the intra prediction mode of the current block is not selected from among the MPMs, second intra identification information for indicating which of the modes excluding the MPMs is selected as the intra prediction mode of the current block is transmitted to the encoder.

Hereinafter, a method of constructing an MPM list will be described. While six MPMs are described as constituting the MPM list, the present invention is not limited thereto. The number of MPMs included in the MPM list may be selected within a range of three to ten.

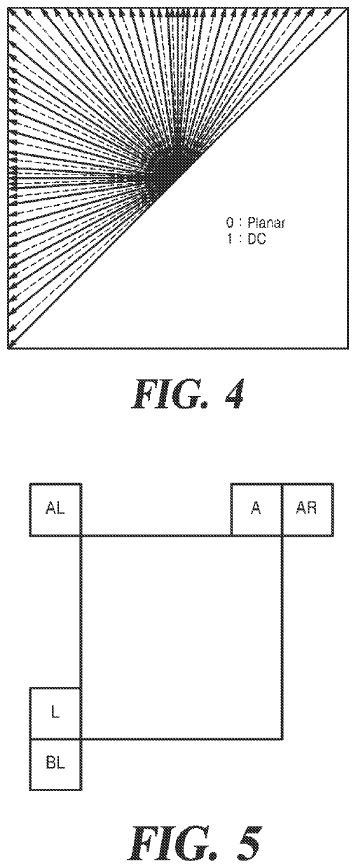

First, MPM candidates are configured using an intra prediction mode of neighboring blocks for the current block. In an example, as shown in FIG. 5, the neighboring blocks may include a part or the entirety of a left block L, a top block A, a bottom left block BL, a top right block AR, and a top left block AL of the current block. Here, the left block L of the current block refers to a block including a pixel at a position shifted one pixel to the left from the position of the leftmost bottom pixel in the current block, and the top block A refers to a block including a pixel at a position shifted up by one pixel from the position of the rightmost top pixel in the current block. The bottom left block BL refers to a block including a pixel at a position shifted one pixel to the left and one pixel downward from the position of the leftmost bottom pixel in the current block. The top right block AR refers to a block including a pixel at a position shifted one pixel upward and one pixel to the right from the position of the rightmost top pixel in the current block, and then the top left block AL refers to a block including a pixel at a position shifted one pixel upward and one pixel to the left from the position of the leftmost top pixel in the current block.

The intra prediction modes of these neighboring blocks are included in the MPM list. Here, the intra prediction modes of the available blocks are included in the MPM list in order of the left block L, the top block A, the bottom left BL, the top right block AR, and the top left block AL. Alternatively, candidates may be configured by adding the planar mode and the DC mode to the intra prediction modes of the neighboring blocks, and then available modes may be added to the MPM list in order of the left block L, the top block A, the planar mode, the DC mode, the bottom left block BL, the top right block AR, and the top left block AL.

Only different intra prediction modes are included in the MPM list. That is, when there are duplicate modes, only one of the duplicate modes is included in the MPM list.

When the number of MPMs in the list is less than a predetermined number (e.g., 6), the MPMs may be derived by adding −1 or +1 to the directional modes in the list. In addition, when the number of MPMs in the list is less than the predetermined number, modes are added to the MPM list in order of the vertical mode, the horizontal mode, the diagonal mode, and so on.

The inter predictor 224 searches for a block most similar to the current block in a reference picture encoded and decoded earlier than the current picture, and generates a prediction block for the current block using the searched block. Then, the inter predictor generates a motion vector corresponding to a displacement between the current block in the current picture and the prediction block in the reference picture. Motion information including information about the reference picture used to predict the current block and information about the motion vector is encoded by the encoder 250 and transmitted to the decoding apparatus.

Various methods may be used to minimize the number of bits required to encode the motion information.

In an example, when the reference picture and the motion vector of the current block are the same as the reference picture and the motion vector of a neighboring block, the motion information about the current block may be transmitted to the decoding apparatus by encoding information by which the neighboring block can be identified. This method is referred to as “merge mode.”

In the merge mode, the inter predictor 224 selects a predetermined number of merge candidate blocks (hereinafter, “merge candidates”) from the neighboring blocks for the current block.

As shown in FIG. 5, a part or the entirety of the left block L, the top block A, the top right block AR, the bottom left block BL, and the top left block AL, which neighbor the current block in the current picture, may be used as the neighboring blocks for deriving merge candidates. In addition, a block located in a reference picture (which may be the same as or different from the reference picture used to predict the current block) rather than the current picture in which the current block is located may be used as a merge candidate. In an example, a co-located block co-located with the current block in the reference picture or blocks neighboring the co-located block may be further used as merge candidates.

The inter predictor 224 constructs a merge list including a predetermined number of merge candidates using such neighboring blocks. A merge candidate of which motion information is to be used as the motion information about the current block is selected from among the merge candidates included in the merge list and merge index information for identifying the selected candidate is generated. The generated merge index information is encoded by the encoder 250 and transmitted to the decoding apparatus.

Another method of encoding motion information is to encode a differential motion vector (motion vector difference).

In this method, the inter predictor 224 derives motion vector predictor candidates for the motion vector of the current block using the neighboring blocks for the current block. The neighboring blocks used to derive the motion vector predictor candidates include a part or the entirety of the left block L, the top block A, the top right block AR, the bottom left block BL, and the top left block AL, which neighbor the current block in the current picture shown in FIG. 5. In addition, a block located in a reference picture (which may be the same as or different from the reference picture used to predict the current block) rather than the current picture in which the current block is located may be used as a neighboring block used to derive motion vector predictor candidates. In an example, a co-located block co-located with the current block in the reference picture or blocks neighboring the co-located block may be used.

The inter predictor 224 derives the motion vector predictor candidates using the motion vectors of the neighboring blocks, and determines a motion vector predictor for the motion vector of the current block using the motion vector predictor candidates. Then, the inter predictor calculates a differential motion vector by subtracting the motion vector predictor from the motion vector of the current block.

The motion vector predictor may be obtained by applying a predefined function (e.g., median value calculation, mean value calculation, etc.) to the motion vector predictor candidates. In this case, the video decoding apparatus is also aware of the predefined function. In addition, since the neighboring blocks used to derive the motion vector predictor candidates have been already encoded and decoded, the video decoding apparatus already knows the motion vectors of the neighboring blocks. Accordingly, the video encoding apparatus does not need to encode information for identifying the motion vector predictor candidates. Accordingly, in this case, the information about the differential motion vector and the information about the reference picture used to predict the current block are encoded.

In another embodiment, the motion vector predictor may be determined by selecting one of the motion vector predictor candidates. In this case, information for identifying the selected motion vector predictor candidate is further encoded together with the information about the differential motion vector and the information about the reference picture used to predict the current block.

The subtractor 230 subtracts the prediction block generated by the intra predictor 222 or the inter predictor 224 from the current block to generate a residual block.

The transformer 240 transforms residual signals in the residual block having pixel values in the spatial domain into transform coefficients in the frequency domain. The transformer 240 may transform the residual signals in the residual block by using the size of the current block as a transform unit, or may split the residual block into a plurality of smaller subblocks and transform residual signals in transform units corresponding to the sizes of the subblocks. There may be various methods of splitting the residual block into smaller subblocks. For example, the residual block may be split into subblocks of the same predefined size, or may be split in a manner of a quadtree (QT) which takes the residual block as a root node.

The quantizer 245 quantizes the transform coefficients output from the transformer 240 and outputs the quantized transform coefficients to the encoder 250.

The encoder 250 encodes the quantized transform coefficients using a coding scheme such as CABAC to generate a bitstream. The encoder 250 encodes information such as a CTU size, a MinQTSize, a MaxBTSize, a MaxBTDepth, a MinBTSize, a QT split flag, a BT split flag, and a split type associated with the block split such that the decoding apparatus splits the block in the same manner as in the encoding apparatus.

The encoder 250 encodes information about a prediction type indicating whether the current block is encoded by intra prediction or inter prediction, and encodes intra prediction information or inter prediction information according to the prediction type.

When the current block is intra-predicted, a syntax element for the intra prediction mode is encoded as the intra prediction information. The syntax element for the intra prediction mode includes the following:

(1) mode information indicating whether the intra prediction mode of the current block is selected from among the MPMs;

(2) in the case where the intra prediction mode of the current block is selected from among the MPMs, first intra identification information for indicating which mode of the MPMs has been selected as the intra prediction mode of the current block;

(3) in the case where the intra prediction mode of the current block is not selected among the MPMs, second intra identification information for indicating which of the other modes that are not among the MPMs has been selected as the intra prediction mode.

On the other hand, when the current block is inter-predicted, the encoder 250 encodes a syntax element for the inter prediction information. The syntax element for the inter prediction information includes the following:

(1) mode information indicating whether the motion information about the current block is encoded in the merge mode or in a mode in which the differential motion vector is encoded; and

(2) a syntax element for motion information.

When the motion information is encoded by the merge mode, the encoder 250 encodes, as the syntax element for the motion information, the merge index information indicating which of the merge candidates is selected as a candidate for extracting the motion information about the current block.

On the other hand, when motion information is encoded by a mode for encoding a differential motion vector, the encoder encodes information about the differential motion vector and information about the reference picture as the syntax element for the motion information. When the motion vector predictor is determined in a manner of selecting one of a plurality of motion vector predictor candidates, the syntax element for the motion information further includes motion vector predictor identification information for identifying the selected candidate.

The inverse quantizer 260 inversely quantizes the quantized transform coefficients output from the quantizer 245 to generate transform coefficients. The inverse transformer 265 transforms the transform coefficients output from the inverse quantizer 260 from the frequency domain to the spatial domain and reconstructs the residual block.

The adder 270 adds the reconstructed residual block to the prediction block generated by the predictor 220 to reconstruct the current block. The pixels in the reconstructed current block are used as reference samples in performing intra prediction of the next block in order.

The filter unit 280 deblock-filters the boundaries between the reconstructed blocks in order to remove blocking artifacts caused by block-by-block encoding/decoding and stores the blocks in the memory 290. When all the blocks in one picture are reconstructed, the reconstructed picture is used as a reference picture for inter prediction of a block in a subsequent picture to be encoded.

The above-described video encoding technique is applied even when a 2D image obtained by projecting 360 sphere onto 2D is encoded.

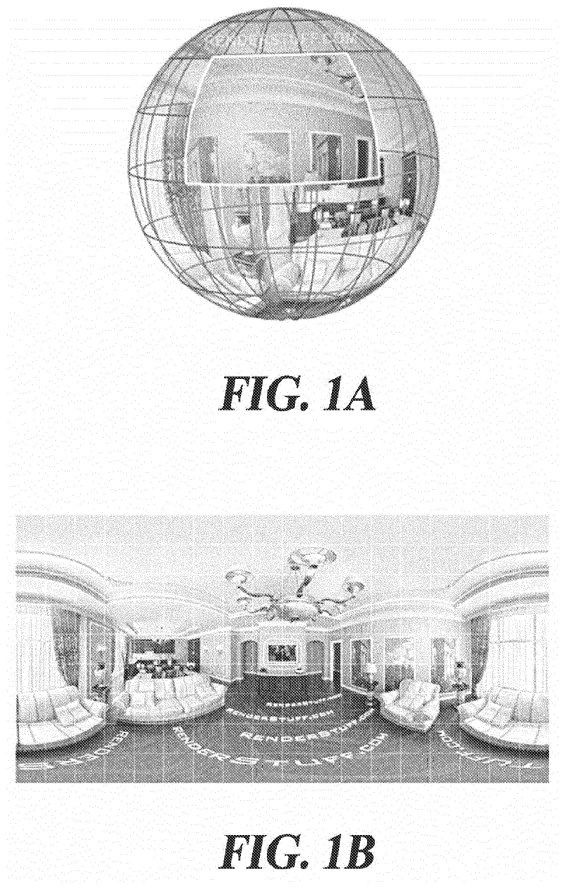

The equirectangular projection, which is a typical projection format used for 360 video, has a disadvantage of causing severe distortion by increasing the pixels in the upper and lower portions of the 2D image in projecting the 2D image onto 360 sphere, and also has a disadvantage of increasing the data amount and encoding throughput in the increased portion in compressing the video. Accordingly, the present invention provides a video encoding technique supporting various projection formats. In addition, regions that do not neighbor each other in the 2D image neighbor each other in the 360 sphere. For example, the left boundary and the right boundary of the 2D image shown in FIG. 1A are arranged to neighbor each other when projected onto 360 sphere. Accordingly, the present invention provides a method of efficiently encoding video by reflecting such a feature of 360 video.

Meta Data for 360 Video

Table 1 below shows an example of metadata of 360 video encoded into a bitstream to support various projection formats.

TABLE 1
360_video( ) {

projection_format_idx
If (projection_format_idx != ERP && projection_format_idx !=
TSP)

compact_layout_flag

If (projection_format == CMP) {

```
num_face_rows_minus1
num_face_columns_minus1
  face_width
  face_height
for( i = 0; i <= num_face_rows_minus1; i++ ) {
```

for( j = 0; j <= num_face_columns_minus1; j++ ) {

face_idx[ i ][ j ]
face_rotation_idx[ i ][ j ]

}

}

}
}

The metadata of the 360 video is encoded at the position of more than one of a Video Parameter Set (VPS), a Sequence Parameter Set (SPS), a Picture Parameter Set (PPS), and Supplementary Enhancement Information (SEI).

1-1) projection_format_idx

This syntax element represents an index indicating a projection format of 360 video. The projection formats according to the values of this index may be defined as shown in Table 2.

TABLE 2

| Index | Projection format | Description |
|---|---|---|
| 0 | ERP | Equirectangular projection |
| 1 | CMP | Cube map projection |
| 2 | ISP | Icosahedron projection |
| 3 | OHP | Octahedron projection |
| 4 | EAP | Equal-area projection |
| 5 | TSP | Truncated square pyramid projection |
| 6 | SSP | Segmented sphere projection |

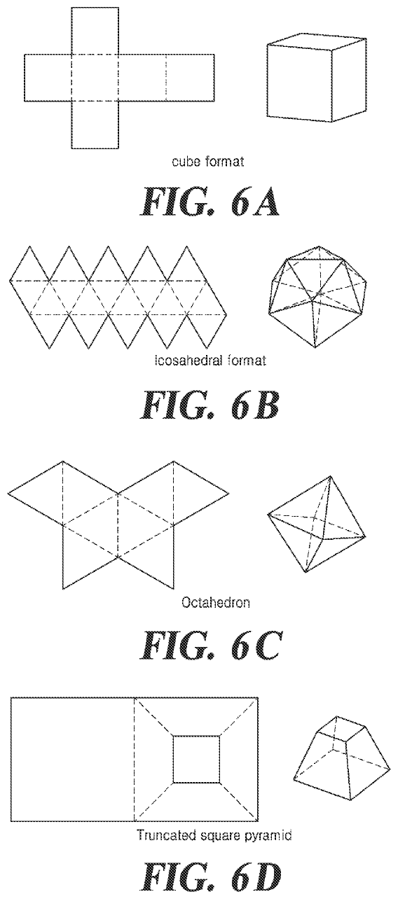

The equirectangular projection is as shown in FIGS. 1A and 1B, and examples of various other projection formats are shown in FIGS. 6A to 6D.

1-2) compact_layout_flag

This syntax element is a flag indicating whether to change the layout of a 2D image onto which 360 sphere is projected. When this flag is 0, a non-compact layout without layout change is used. When the flag is 1, a rectangular compact layout with no blanks, which is formed by rearranging the respective faces, is used.

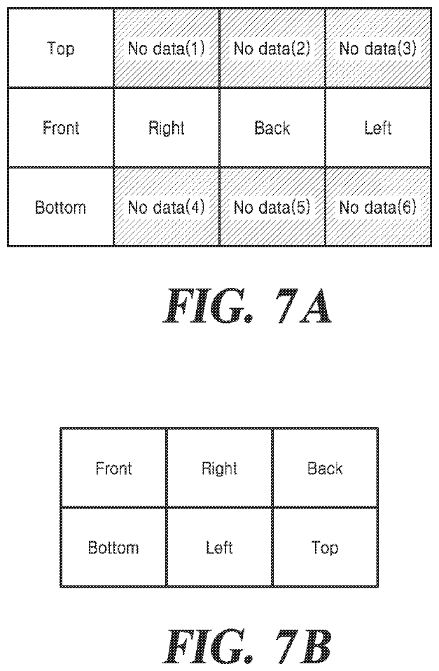

FIGS. 7A and 7B are an exemplary diagram of the layout of a cube projection format. FIG. 7A shows a non-compact layout without layout change, and FIG. 7B shows a compact layout formed by layout change.

1-3) num_face_rows_minus1 and num_face_columns_minus1

num_face_rows_minus1 indicates the value (the number of faces−1) with respect to the horizontal axis, and num_face_columns_minus1 indicates the value (the number of faces−1) with respect to the vertical axis. For example, num_face_rows_minus1 is 2 and num_face_columns_minus1 is 3 in the case of FIG. 7 A. In the case of FIG. 7B, num_face_rows_minus1 is 1 and num_face_columns_minus1 is 2.

1-4) face_width and face_height

These syntaxes indicate the width information about a face (the number of luma pixels in the horizontal direction) and the height information (the number of luma pixels in the vertical direction). However, since the resolutions of faces determined by these syntaxes can be sufficiently inferred from num_face_rows_minus1 and num_face_columns_minus1, these syntaxes may not be encoded.

1-5) face_idx

This syntax element is an index indicating the position of each face in 360 cube. This index may be defined as shown in Table 3.

TABLE 3

| face_idx | location |
|---|---|
| 0 | Top |
| 1 | Bottom |
| 2 | Front |
| 3 | Right |
| 4 | Back |
| 5 | Left |
| 6 | Null |

In the case where there is a blank area (i.e., face) as in the non-compact layout of FIG. 7A, an index value (e.g., 6) indicating “null” is set to the blank face, and encoding for the face set to null may be omitted. For example, in the case of the non-compact layout of FIG. 7A, the index values for each face may be 0 (top), 6 (null), 6 (null), 6 (null), 2 (front), 3 (right), 4 (back), 5 (left), 1 (bottom), 6 (null), 6 (null), and 6 (null) in raster scan order.

1-6) face_rotation_idx

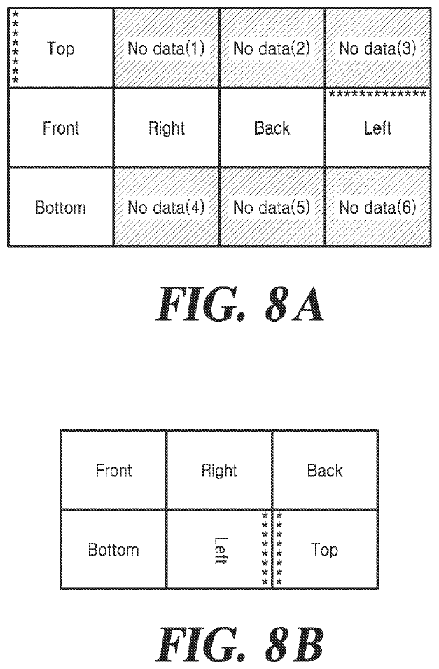

This syntax element is an index indicating rotation information about each face. When faces are rotated in the 2D layout, the faces that are adjacent in 3D sphere can adjacently be arranged in the 2D layout. For example, in FIG. 8A, the upper boundary of the Left face and the left boundary of the Top face are in contact with each other in 360 sphere. Accordingly, when the layout of FIG. 8A is changed to the compact layout in FIG. 7B and then the Left face is rotated by 270 degrees (−90 degrees), continuity between the Left face and the Top face may be maintained as shown in FIG. 8B. Accordingly, face_rotation_idx is defined as a syntax element for rotation of each face. This index may be defined as shown in Table 4.

TABLE 4

| Index | Counterclockwise face rotation |
|---|---|
| 0 | 0 |
| 1 | 90 |
| 2 | 180 |
| 3 | 270 |

While Table 1 describes that the syntax elements of 1-3) to 1-6) are encoded when the projection format is a cube projection format, such syntax elements may be used even for formats such as icosahedron and octahedron other than the cube projection format. In addition, not all the syntax elements defined in Table 1 need to be encoded. Some syntax elements may not be encoded depending on the defined metadata of the 360 video. For example, in the case that a compact layout or face rotation is not applied, syntax elements such as compact_layout_flag and face_rotation_idx may be omitted.

Prediction of 360 Video

In the 2D layout of 360 video, a single face or a region that is a bundle of adjacent faces is designated as a single tile or slice or as a picture. In video encoding, each tile or slice can be handled independently because the tiles or slices have no dependency on each other. In predicting a block included in each tile or slice, other tiles or slices are not referenced. Accordingly, when a block located at a boundary of a tile or slice is predicted, there may be no neighboring block outside of the boundary for the block. The conventional video encoding apparatus pads the pixel value of the non-existent neighboring block with a predetermined value or considers the block as an unavailable block.

However, regions that do not neighbor each other in the 2D layout may neighbor each other based on 360 sphere. Accordingly, the present invention needs to predict the current block to be encoded or encode the prediction information about the current block, considering such characteristic of the 360 video.

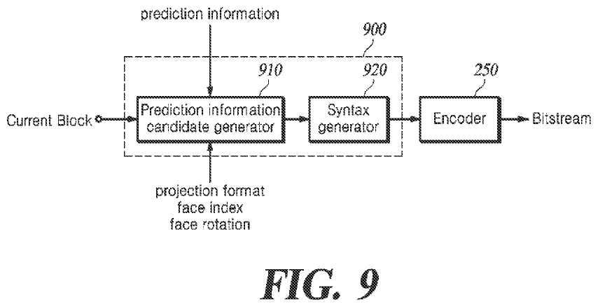

FIG. 9 is a block diagram of an apparatus configured to generate a syntax element for prediction information about a current block in a 360 video according to an embodiment of the present invention.

The apparatus 900 includes a prediction information candidate generator 910 and a syntax generator 920.

The prediction information candidate generator 910 generates prediction information candidates using neighboring blocks for the current block located on a first face of the 2D layout onto which 360 sphere is projected. The neighboring blocks are blocks located at predetermined positions around the current block and may include a part or the entirety of a left block L, a above block A, a bottom left block BL, a above right block AR, and a above left AL, as shown in FIG. 5,

When the current block adjoins the border of the first face, i.e., when the border of the current block coincides with the border of the first face, some of the neighboring blocks at the predetermined positions may not be located in the first face. For example, in the case where the current block neighbors the upper border of the first face, the above block A, the above right block AR and the above left block AL in FIG. 5 are not located in the first face. In conventional video encoding, these neighboring blocks are regarded as invalid blocks and thus are not used. However, in the present invention, when the current block aligns with the border of the first face, neighboring blocks of the current block are determined based on the 360 sphere rather than the 2D layout. That is, blocks adjacent to the current block in the 360 sphere are determined as the neighboring blocks. Here, the prediction information candidate generator 910 may regard blocks adjacent to the current block based on the 360 sphere as the neighboring blocks of the current block, based on at least one of the projection format of the 360 video, the face index and the face rotation information. For example, in the case of the equirectangular projection format, there is one face, and neighboring blocks of the current block may be distinguished based on only the projection format, except for the face index or rotation information about the face. In the case of a projection format having a plurality of faces in contrast with the equirectangular projection, neighboring blocks of the current block may be distinguished based on the face index in addition to the projection format. In the case when a face is rotated, not only the face index but also the face rotation information may be used to distinguish the neighboring blocks of the current block.

For example, when the border of the current block coincides with the border of the first face, the prediction information candidate generator 910 identifies a second face that contacts the border of the current block based on the 360 sphere and has been already encoded. Here, whether the border of the current block coincides with the border of the first face may be determined by the position of the current block, for example, the position of the top leftmost pixel in the current block. The second face is identified using at least one of the projection format, the face index and the face rotation information. The prediction information candidate generator 910 selects a block that is located in the second face and adjoins the current block on the 360 sphere as a neighboring block for the current block.

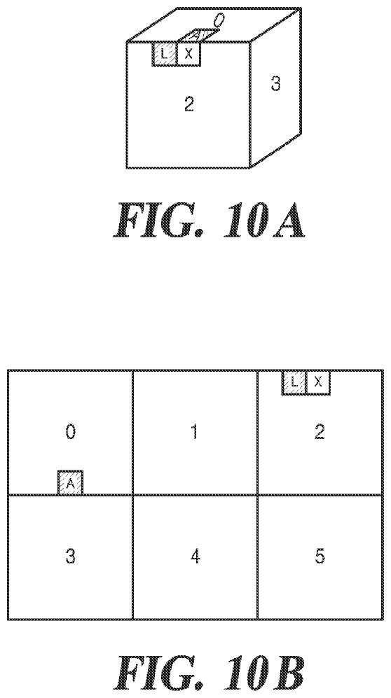

FIGS. 10A and 10B are an exemplary diagram for explaining a method of determining a neighboring block of a current block in a cube format to which a compact layout is applied.

In FIGS. 10A and 10B, the numbers marked on each face represent the indexes of the faces. As shown in Table 3, 0 indicates the top face, 1 indicates the bottom face, 2 indicates the front face, 3 denotes the right face, 4 denotes the back face, and 5 denotes the left face. When the current block X adjoins the upper border of the front face 2 in the compact layout of FIG. 10B, the left neighboring block L of the current block is located in the same front face 2, whereas the above neighboring block A located at the top of the current block is not located in the front face 2. However, as shown in FIG. 10A, when the compact layout is projected onto 360 sphere according to the cube format, the upper border of the front face 2, which the current block contacts, adjoins the lower border of the top face 0. In addition, the above block A adjoining the current block X is located in the top face 0 at the lower border of the top face. Accordingly, the above block A of the top face 0 is regard as a neighboring block of the current block.

The encoder 250 of the encoding apparatus shown in FIG. 2 may further encode a flag indicating whether or not reference between different faces is allowed. Determining the neighboring block for the current block based on the 360 sphere may result in decrease in execution speed of the encoder and the decoder due to dependency of the faces on each other. In order to overcome this, the flag may be encoded in a header such as the sequence parameter set (SSP) or the picture parameter set (PPS). In this case, when the flag is on (e.g., flag=1), the prediction information candidate generator 910 determines a neighboring block for the current block based on the 360 sphere. When the flag is off (e.g., flag=0), a neighboring block is independently determined on each face based on the 2D image as in the conventional cases rather than on the 360 video.

The syntax generator 920 encodes the syntax element for the prediction information about the current block using the prediction information candidates generated by the prediction information candidate generator 910. Here, the prediction information may be inter prediction information or intra prediction information.

An embodiment of a case where the apparatus of FIG. 9 is applied to intra prediction and inter prediction will be described.

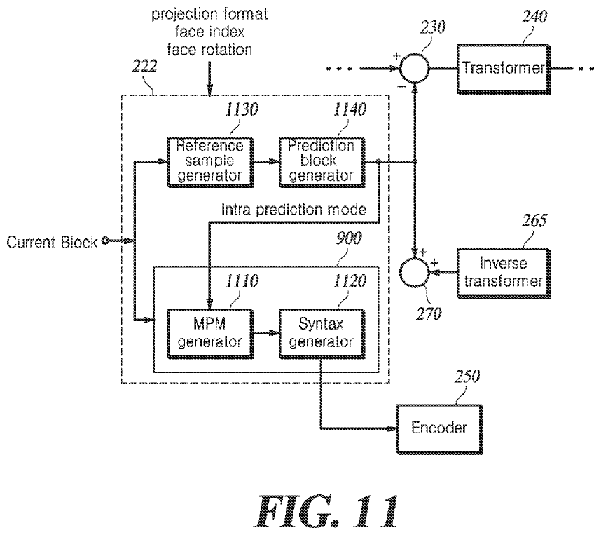

FIG. 11 is a diagram showing a detailed configuration of the intra predictor of FIG. 2 when the apparatus of FIG. 9 is applied to intra prediction.

The intra predictor 222 of this embodiment includes an MPM generator 1110 and a syntax generator 1120. These elements correspond to the prediction information candidate generator 910 and the syntax generator 920, respectively.

As described above, the MPM generator 1110 determines the intra prediction modes of the neighboring blocks for the current block to generate an MPM list. Since the method of constructing the MPM list has already been described in relation to the intra predictor 222 of FIG. 2, further description thereof is omitted.

When the border of the current block is as aligned with the border of the face in which the current block is located, the MPM generator 1110 determines a block adjoining the current block in 360 sphere as a neighboring block for the current block. For example, as shown in FIGS. 10A and 10B, when the current block X adjoins the upper border of the front face 2, the above block A, the above right block AR, and the above left block AL are not located in the front face 2. Accordingly, the top face 0 adjoining the upper border of the front face 2 is identified in the 360 video, and blocks corresponding to the above block A, the above right block AR, and the above left block AL in the top face 0 are regard as the neighboring blocks of the current block based on the position of the current block.

The syntax generator 1120 generates a syntax element for the intra prediction mode of the current block using the modes included in the MPM list and outputs the generated syntax element to the encoder 250. That is, the syntax generator 1120 determines whether the intra prediction mode of the current block is the same as one of the MPMs, and generates mode information indicating whether the intra prediction mode of the current block is the same as one of the MPMs. When intra prediction information about the current block is same as the MPMs, the syntax generator generates first identification information indicating which of the MPMs is selected as the intra prediction mode of the current block. When the intra prediction information about the current block is not same as the MPMs, second identification information indicating the intra prediction mode of the current block among the remaining modes excluding the MPMs from a plurality of intra prediction modes is generated. The generated mode information, the first identification information and/or the second identification information are output to the encoder 250 and are encoded by the encoder 250.

The intra predictor 222 may further include a reference sample generator 1130 and a prediction block generator 1140.

The reference sample generator 1130 sets the pixels in reconstructed samples located around the current block as reference samples. For example, the reference sample generator may set, as reference samples, the reconstructed samples located on the top and top right side of the current block and the reconstructed samples located on the left side, top left side and bottom left side of the current block. The samples located on the top and top right side may include one or more rows of samples around the current block. The samples located on the left side, top left side, and bottom left side may include one or more columns of samples around the current block.

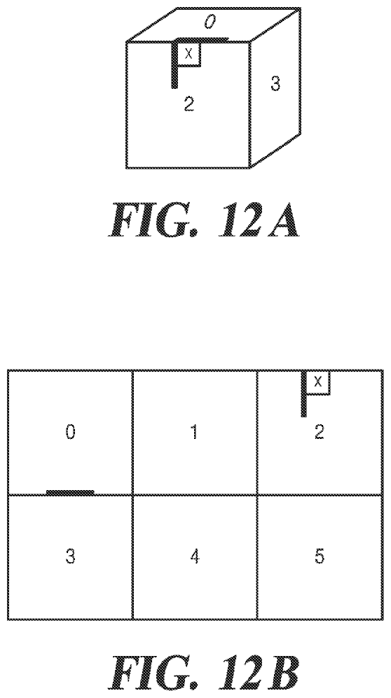

When the border of the current block coincides with the border of the face in which the current block is located, the reference sample generator 1130 sets reference samples for the current block based on 360 sphere. The principle is as described with reference to FIGS. 10A and 10B. For example, referring to FIGS. 12A and 12B, in the 2D layout, there are reference samples on the left side and bottom left side of the current block X located in the front face 2, but there is no reference sample on the top side, top right side, and top left side. However, when the compact layout is projected onto 360 sphere according to the cube format, the upper border of the front face 2 that the current block adjoins is adjacent to the lower border of the upper face 0. Accordingly, the samples corresponding to the top side, the top right side, and the top left side of the current block at the lower border of the upper face 0 are set as reference samples.

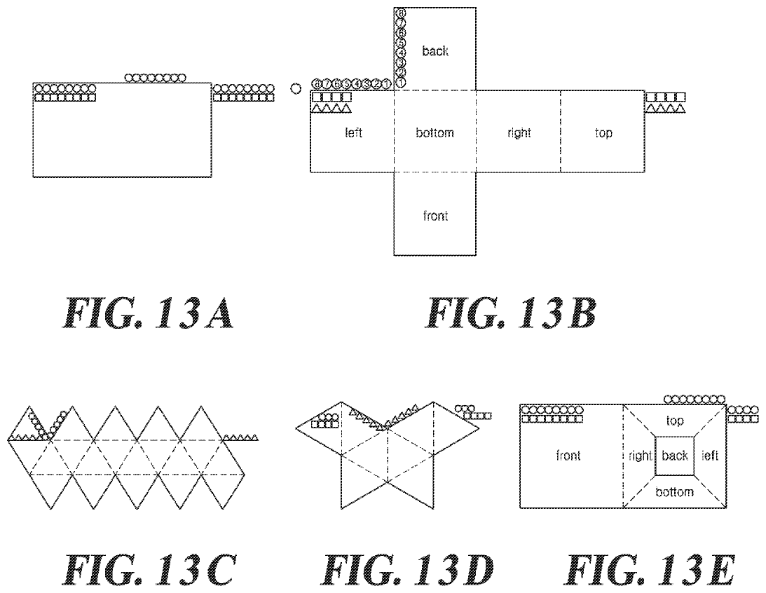

FIGS. 13A to 13E are an exemplary diagram for explaining a method of configuring reference samples for intra prediction in various projection formats. As shown in FIG. 13A to 13E, the positions where no reference sample is present are padded with pixels located around the current block based on the 360 video. The padding is determined in consideration of the position where the pixels contact each other in the 360 video. For example, in the case of the cube format in FIG. 13B, pixels 1 to 8 sequentially located from the bottom to the top at the left border of the back face are sequentially padded to the neighboring pixels located on the top of the left face from right to left. However, the present invention is not limited thereto. In some cases, padding can be performed in the reverse direction. For example, in FIG. 13B, pixels 1 to 8 located from the bottom to the top at the left border of the back face may be sequentially padded to the pixels positioned on the top of the left face from right to left.

The prediction block generator 1140 generates the prediction block of the current block using the reference samples set by the reference sample generator 1130 and determines the intra prediction mode of the current block. The determined intra prediction mode is input to the MPM generator 1110. The MPM generator 1110 and the syntax generator 1120 generate a syntax element for the determined intra prediction mode and output the generated syntax element to the encoder.

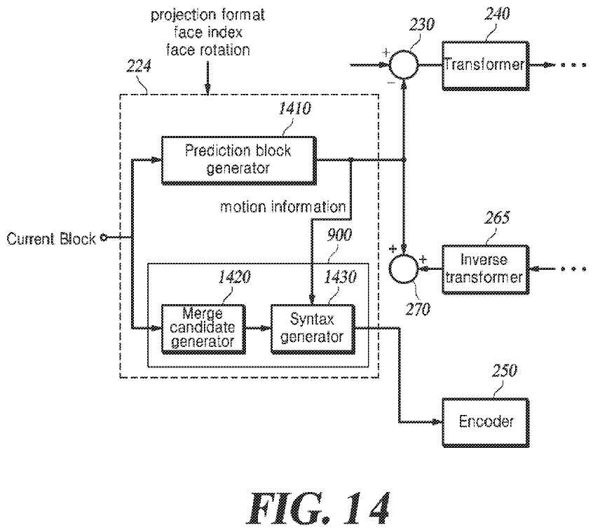

FIG. 14 is a diagram showing a detailed configuration of the inter predictor 224 when the apparatus of FIG. 9 is applied to inter prediction.

When the apparatus of FIG. 9 is applied to inter prediction, the inter predictor 224 includes a prediction block generator 1410, a merge candidate generator 1420, and a syntax generator 1430. The merge candidate generator 1420 and the syntax generator 1430 correspond to the prediction information candidate generator 910 and the syntax generator 920 in FIG. 9.

The prediction block generator 1410 searches for a block having a sample value most similar to the pixel value of the current block in the reference picture and generates a motion vector and a prediction block of the current block. Then, the prediction block generator outputs the generated vector and block to the subtractor 230 and the adder 270, and outputs motion information including information about the motion vector and the reference picture to the syntax generator 1430.

The merge candidate generator 1420 generates a merge list including merge candidates using neighboring blocks for the current block. As described above, a part or the entirety of the left block L, the above block A, the above right block AR, the bottom left block BL, and the above left block AL shown in FIG. 5 may be used as the neighboring blocks for generating merge candidates.

When the border of the current block coincides with the border of the first face in which the current block is located, the merge candidate generator 1420 determines a neighboring block of the current block based on 360 sphere. A block adjacent to the current block in 360 sphere is selected as the neighboring block of the current block. The merge candidate generator 1420 is an element corresponding to the prediction information candidate generator 910 of FIG. 9. Accordingly, all functions of the prediction information candidate generator 910 may be applied to the merge candidate generator 1420, and thus further detailed description thereof will be omitted.

The syntax generator 1430 generates a syntax element for the inter prediction information about the current block using the merge candidates included in the merged list. First, mode information indicating whether the current block is to be encoded in the merge mode is generated. When the current block is encoded in the merge mode, the syntax generator 1430 generates merge index information indicating a merge candidate whose motion information is to be set as motion information about the current block among the merge candidates included in the merge list.

When the current block is not encoded in the merge mode, the syntax generator 1430 generates information about a motion vector difference and information about a reference picture used to predict the current block (i.e., referred to by the motion vector of the current block).

The syntax generator 1430 determines a motion vector predictor for the motion vector of the current block to generate a motion vector difference. As described in relation to the inter predictor 224 of FIG. 2, the syntax generator 1430 derives motion vector predictor candidates using neighboring blocks for the current block, and determines a motion vector predictor for the motion vector of the current block from the motion vector predictor candidates. Here, when the border of the current block coincides with the border of the first face in which the current block is located, a neighboring block is determined as a block that adjoins the current block based on the 360 sphere in the same manner as in the merge candidate generator 1420.

When a motion vector predictor for the motion vector of the current block is determined by selecting one of the motion vector predictor candidates, the syntax generator 1430 further generates motion vector predictor identification information for identifying a candidate selected as a motion vector predictor from among the motion vector predictor candidates.

The syntax element generated by the syntax generator 1430 is encoded by the encoder 250 and transmitted to the decoding apparatus.

Hereinafter, a video decoding apparatus will be described.

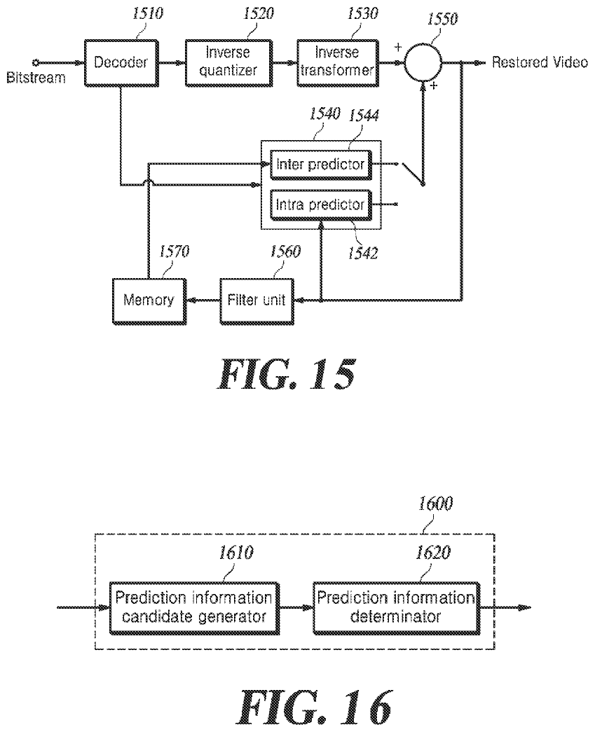

FIG. 15 is a block diagram illustrating a video decoding apparatus according to an embodiment of the present invention.

The video decoding apparatus includes a decoder 1510, an inverse quantizer 1520, an inverse transformer 1530, a predictor 1540, an adder 1550, a filter unit 1560, and a memory 1570. As in the case of the video encoding apparatus of FIG. 2, each element of the video encoding apparatus may be implemented as a hardware chip, or may be implemented as software, and the microprocessor may be implemented to execute the functions of the software corresponding to the respective elements.

The decoder 1510 decodes a bitstream received from the video encoding apparatus, extracts information related to block splitting to determine a current block to be decoded, and outputs prediction information necessary to reconstruct the current block and information about a residual signal.

The decoder 1510 extracts information about the CTU size from the Sequence Parameter Set (SPS) or the Picture Parameter Set (PPS), determines the size of the CTU, and splits a picture into CTUs of the determined size. Then, the decoder determines the CTU as the uppermost layer, that is, the root node, of a tree structure, and extracts split information about the CTU to split the CTU using the tree structure. For example, when the CTU is split using the QTBT structure, a first flag (QT_split_flag) related to the QT split is first extracted and each node is split into four nodes of a lower layer. For a node corresponding to a leaf node of the QT, a second flag (BT_split_flag) and a split type related to the BT split are extracted to split the leaf node of the QT in the BT structure.

In the example of the block split structure of FIGS. 3A and 3B, QT_split_flag corresponding to the node of the uppermost layer of the QTBT structure is extracted. Since the value of the extracted QT_split_flag is 1, the node of the uppermost layer is split into four nodes of a lower layer (layer 1 of QT). Then, the QT_split_flag for the first node of layer 1 is extracted. Since the value of the extracted QT_split_flag is 0, the first node of layer 1 is not further split in the QT structure.

Since the first node of layer 1 of QT is a leaf node of QT, the operation precedes to a BT which takes the first node of layer 1 of QT as a root node of the BT. BT_split_flag corresponding to the root node of the BT, that is, ‘(layer 0)’, is extracted. Since BT_split_flag is 1, the root node of the BT is split into two nodes of ‘(layer 1)’. Since the root node of BT is split, split type information indicating whether the block corresponding to the root node of BT is vertically split or horizontally split is extracted. Since the split type information is 1, the block corresponding to the root node of BT is vertically split. Then, the decoder 1510 extracts BT_split_flag for the first node of ‘(layer 1)’ which is split from the root node of the BT. Since BT_split_flag is 1, the split type information about the block of the first node of ‘(layer 1)’ is extracted. Since the split type information about the block of the first node of ‘(layer 1)’ is 1, the block of the first node of ‘(layer 1)’ is vertically split. Then, BT_split_flag of the second node of ‘(layer 1)’ split from the root node of the BT is extracted. Since BT_split_flag is 0, the node is not further split by the BT.

In this way, the decoder 1510 recursively extracts QT_split_flag and splits the CTU in the QT structure. The decoder extracts BT_split_flag for a leaf node of the QT. When BT_split_flag indicates splitting, the split type information is extracted. In this way, the decoder 1510 may confirm that the CTU is split into a structure as shown in FIG. 3A.

When information such as MinQTSize, MaxBTSize, MaxBTDepth, and MinBTSize is additionally defined in the SPS or PPS, the decoder 1510 extracts the additional information and uses the additional information in extracting split information about the QT and the BT.

In the QT, for example, a block having the same size as MinQTSize is not further split. Accordingly, the decoder 1510 does not extract the split information (a QT split flag) related to the QT of the block from the bitstream (i.e., there is no QT split flag of the block in the bitstream), and automatically sets the corresponding value to 0. In addition, in the QT, a block having a size larger than MaxBTSize does not have a BT. Accordingly, the decoder 1510 does not extract the BT split flag for a leaf node having a block larger than MaxBTSize in the QT, and automatically sets the BT split flag to 0. Further, when the depth of a corresponding node of BT reaches MaxBTDepth, the block of the node is not further split. Accordingly, the BT split flag of the node is not extracted from the bit stream, and the value thereof is automatically set to 0. In addition, a block having the same size as MinBTSize in the BT is not further split. Accordingly, the decoder 1510 does not extract the BT split flag of the block having the same size as MinBTSize from the bitstream, and automatically sets the value of the flag to 0.

In an embodiment, upon determining a current block to be decoded through splitting of the tree structure, the decoder 1510 extracts information about the prediction type indicating whether the current block is intra-predicted or inter-predicted.

When the prediction type information indicates intra prediction, the decoder 1510 extracts a syntax element for the intra prediction information about the current block (intra prediction mode). First, the decoder extracts mode information indicating whether the intra prediction mode of the current block is selected from among the MPMs. When the intra mode encoding information indicates that the intra prediction mode of the current block is selected from among the MPMs, the decoder extracts first intra prediction information for indicating which mode of the MPMs is selected as the intra prediction mode of the current block. On the other hand, when the intra mode encoding information indicates that the intra prediction mode of the current block is not selected from among the MPMs, the decoder extracts second intra identification information for indicating which of the modes excluding the MPMs is selected as the intra prediction mode of the current block.

When the prediction type information indicates inter prediction, the decoder 1510 extracts a syntax element for the inter prediction information. First, mode information indicating a mode in which the motion information about the current block is encoded among a plurality of encoding modes is extracted. Here, the plurality of encoding modes includes a merge mode and a differential motion vector encoding mode. When the mode information indicates the merge mode, the decoder 1510 extracts, as a syntax element for the motion information, merge index information indicating a merge candidate to be used to derive a motion vector of the current block among the merge candidates. On the other hand, when the mode information indicates the differential motion vector encoding mode, the decoder 1510 extracts information about the differential motion vector and information about a reference picture referenced by the motion vector of the current block, as syntax elements for the motion vector. When the video encoding apparatus uses any one of the plurality of motion vector predictor candidates as the motion vector predictor of the current block, motion vector predictor identification information is included in the bitstream. Accordingly, in this case, not only the information about the differential motion vector and the information about the reference picture but also the motion vector predictor identification information are extracted as the syntax element for the motion vector.

The decoder 1510 extracts information about quantized transform coefficients of the current block as information about the residual signals.

The inverse quantizer 1520 inversely quantizes the quantized transform coefficients. The inverse transformer 1530 inversely transforms the inversely quantized transform coefficients from the frequency domain to the spatial domain to reconstruct the residual signals, and thereby generates a residual block for the current block.

The predictor 1540 includes an intra predictor 1542 and an inter predictor 1544. The intra predictor 1542 is activated when the prediction type of the current block is intra prediction, and the inter predictor 1544 is activated when the prediction type of the current block is inter prediction.

The intra predictor 1542 determines an intra prediction mode of the current block among the plurality of intra prediction modes from the syntax element for the intra prediction mode extracted from the decoder 1510, and predicts the current block using reference samples around the current block according to the intra prediction mode.

To determine the intra prediction mode of the current block, the intra predictor 1542 constructs an MPM list including a predetermined number of MPMs from the neighboring blocks around the current block. The method of constructing the MPM list is the same as that for the intra predictor 222 of FIG. 2. When the intra prediction mode information indicates that the intra prediction mode of the current block is selected from among the MPMs, the intra predictor 1542 selects, as the intra prediction mode of the current block, the MPM indicated by the first intra identification information among the MPMs in the MPM list. On the other hand, when the mode information indicates that the intra prediction mode of the current block is not selected from among the MPMs, intra predictor 1542 selects the intra prediction mode of the current block among the intra prediction modes other than the MPMs in the MPM list, using the second intra identification information.

The inter predictor 1544 determines the motion information about the current block using the syntax element for the inter prediction information extracted by the decoder 1510, and predicts the current block using the determined motion information.

First, the inter predictor 1544 checks the mode information in the inter prediction, which is extracted by the decoder 1510. When the mode information indicates the merge mode, the inter predictor 1544 constructs a merge list including a predetermined number of merge candidates using the neighboring blocks around the current block. The method for the inter predictor 1544 to construct the merge list is the same as that for the inter predictor 224 of the video encoding apparatus. Then, one merge candidate is selected from among the merge candidates in the merge list using merge index information received from the decoder 1510. Then, the motion information about the selected merge candidate, that is, the motion vector and the reference picture of the merge candidate are set as the motion vector and the reference picture of the current block.

When the mode information indicates the differential motion vector encoding mode, the inter predictor 1544 derives the motion vector predictor candidates using the motion vectors of the neighboring blocks, and determines a motion vector predictor for the motion vector of the current block using the motion vector predictor candidates. The method for the inter predictor 1544 to derive the motion vector predictor candidates is the same as that for the inter predictor 224 of the video encoding apparatus. When the video encoding apparatus uses any one of the plurality of motion vector predictor candidates as the motion vector predictor of the current block, the syntax element for the motion information includes motion vector predictor identification information. Accordingly, in this case, the inter predictor 1544 may select the candidate indicated by the motion vector predictor identification information from among the motion vector predictor candidates as the motion vector predictor. However, when the video encoding apparatus determines a motion vector predictor using a function predefined for a plurality of motion vector predictor candidates, the inter predictor may determine the motion vector predictor by applying the same function as that of the video encoding apparatus. Once the motion vector predictor of the current block is determined, the inter predictor 1544 derives the motion vector of the current block by adding the motion vector predictor and the differential motion vector delivered from the decoder 1510. Then, the inter predictor determines a reference picture referenced by the motion vector of the current block, using the information about the reference picture delivered from the decoder 1510.

When the motion vector and the reference picture of the current block are determined in the merge mode or differential motion vector encoding mode, the inter predictor 1542 generates a prediction block for the current block using the block indicated by the motion vector in the reference picture.

The adder 1550 adds the residual block output from the inverse transformer and the prediction block output from the inter predictor or intra predictor to reconstruct the current block. The pixels in the reconstructed current block are utilized as reference samples for intra prediction of a block to be decoded later.

The filter unit 1560 deblock-filters the boundaries between the reconstructed blocks in order to remove blocking artifacts caused by block-by-block decoding and stores the deblock-filtered blocks in the memory 1570. When all the blocks in one picture are reconstructed, the reconstructed picture is used as a reference picture for inter prediction of blocks in a subsequent picture to be decoded.

The video decoding technique described above is applied even when 360 sphere projected onto 2D and encoded in 2D is decoded.

In the case of 360 video, as described above, the metadata of the 360 video is encoded at the position of more than one of the Video Parameter Set (VPS), the Sequence Parameter Set (SPS), the Picture Patameter Set (PPS), and the Supplementary Enhancement Information (SEI). Accordingly, the decoder 1510 extracts (i.e., parses) the metadata of the 360 video at the corresponding position. The parsed metadata is used to reconstruct the 360 video. In particular, the metadata may be used to predict the current block or to decode prediction information about the current block.

FIG. 16 is a block diagram of an apparatus configured to determine prediction information about a current block in 360 video according to an embodiment of the present invention.

The apparatus 1600 includes a prediction information candidate generator 1610 and a prediction information determinator 1620.

The prediction information candidate generator 1610 generates prediction information candidates using neighboring blocks around the current block located on a first face of the 2D layout onto which 360 sphere is projected. In particular, when the border of the current block coincides with the border of the first face, that is, when the current block adjoins the border of the first face, the prediction information candidate generator 1610 sets a block adjoining the current block in the 360 sphere as a neighboring block of the current block even if the block does not adjoin the current block in the 2D layout. As an example, when the border of the current block coincides with the border of the first face, the prediction information candidate generator 910 identifies a second face that adjoins the border of the current block and has been already decoded. The second face is identified using one or more of the projection format, the face index, and the face rotation information in the metadata of the 360 video. The method for the prediction information candidate generator 1610 to determine a neighboring block around the current block based on the 360 sphere is the same as that for the prediction information candidate generator 910 of FIG. 9, and thus a further detailed description thereof will be omitted.

The prediction information determinator 1620 reconstructs the prediction information about the current block using the prediction information candidates generated by the prediction information candidate generator 1610 and a syntax element for the prediction information parsed by the decoder 1510, i.e., a syntax element for intra prediction information or a syntax element for inter prediction information.

Hereinafter, an embodiment of a case where the apparatus of FIG. 16 is applied to intra prediction and inter prediction will be described.

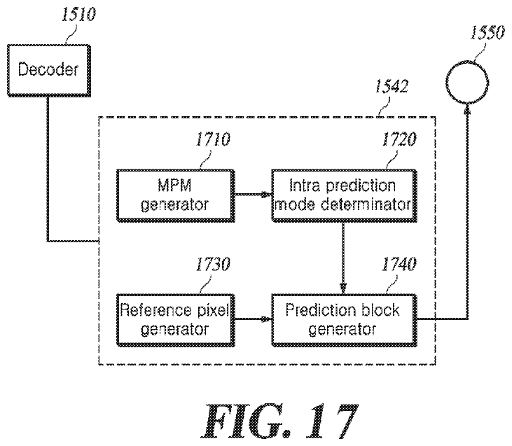

FIG. 17 is a diagram showing a detailed configuration of the intra predictor 1542 when the apparatus of FIG. 16 is applied to intra prediction.

When the apparatus of FIG. 16 is applied to intra prediction, the intra predictor 1542 includes an MPM generator 1710, an intra prediction mode determinator 1720, a reference sample generator 1730, and a prediction block generator 1740. Here, the MPM generator 1710 and the intra prediction mode determinator 1720 correspond to the prediction information candidate generator 1610 and the prediction information determinator 1620, respectively.

The MPM generator 1710 constructs an MPM list by deriving MPMs from the intra prediction modes of the neighboring blocks around the current block. In particular, when the border of the current block coincides with the border of the first face in which the current block is located, the MPM generator 1710 determines a neighboring block around the current block based on the 360 sphere, not the 2D layout. That is, even when there is no neighboring block around the current block in the 2D layout, any block that adjoins the current block in the 360 sphere is set as a neighboring block around the current block. The method for the MPM generator 1710 to determine the neighboring blocks is the same as that for the MPM generator 1110 of FIG. 11.

The intra prediction mode determinator 1720 determines an intra prediction mode of the current block from the modes in the MPM list generated by the MPM generator 1710 and syntax elements for the intra prediction mode parsed by the decoder 1510. That is, when the mode information indicates that the intra prediction mode of the current block is determined from the MPM list, the intra prediction mode determinator 1720 determines a mode identified by the first intra identification information among the MPM candidates belonging to the MPM list as the intra prediction mode of the current block. On the other hand, the mode information indicates that the intra prediction mode of the current block is not determined from the MPM list, the intra prediction mode determinator determines, using the second intra-prediction information, the intra prediction mode of the current block among the remaining intra prediction modes excluding the modes in the MPM list from a plurality of intra prediction modes (namely, all intra prediction modes available for intra prediction of the current block).

The reference sample generator 1730 sets the pixels in a reconstructed sample located around the current block as reference samples. When the border of the current block coincides with the border of the first face in which the current block is located, the reference sample generator 1730 sets the reference samples based on the 360 sphere, not the 2D layout. The method for the reference sample generator 1730 to set the reference samples is the same as that for the reference sample generator 1130 of FIG. 11.

The prediction block generator 1740 selects reference samples corresponding to the intra prediction mode of the current block from among the reference samples and generates a prediction block for the current block by applying an equation corresponding to the intra prediction mode of the current block to the selected reference samples.

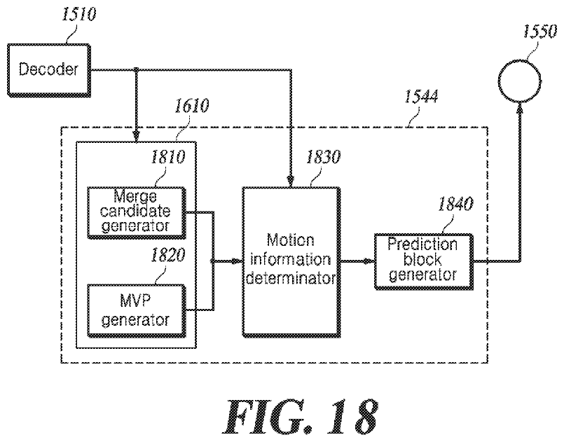

FIG. 18 is a diagram showing a detailed configuration of the inter predictor 1544 when the apparatus of FIG. 16 is applied to inter prediction.

When the apparatus of FIG. 16 is applied to inter prediction, the inter predictor 1544 includes a merge candidate generator 1810, a motion vector predictor (MVP) candidate generator 1820, a motion information determinator 1830, and a prediction block generator 1840. The merge candidate generator 1810 and the MVP candidate generator 1820 correspond to the prediction information candidate generator 1610 of FIG. 16. The motion information determinator 1830 corresponds to the prediction information determinator 1620 in FIG. 16.

The merge candidate generator 1810 is activated when the mode information about inter prediction parsed by the decoder 1510 indicates the merge mode. The merge candidate generator 1810 generates a merge list including merge candidates using neighboring blocks around the current block. In particular, when the border of the current block coincides with the border of the first face in which the current block is located, the merge candidate generator 1420 determines a block adjoining the current block based on 360 sphere as a neighboring block. That is, the merge candidate generator sets a block adjoining the current block in the 360 sphere as a neighboring block around the current block even if the block does not adjoin the current block in the 2D layout. The merge candidate generator 1810 is the same as the merge candidate generator 1420 of FIG. 14.

The MVP candidate generator 1820 is activated when the mode information about the inter prediction mode parsed by the decoder 1510 indicates the motion vector difference encoding mode. The MVP candidate generator 1820 determines a candidate (motion vector predictor candidate) for the motion vector prediction of the current block using the motion vectors of the neighboring blocks around the current block. The method for the MVP candidate generator 1820 to determine the motion vector predictor candidates is the same as that for the syntax generator 1430 to determine the motion vector predictor candidates in FIG. 140. For example, as in the syntax generator 1430 of FIG. 14, when the border of the current block coincides with the border of the first face in which the current block is located, the MVP candidate generator 1820 determines a block adjoining the current block based on the 360 sphere as a neighboring block of the current block.

The motion information determinator 1830 reconstructs the motion information about the current block, by using either the merge candidate or motion vector predictor candidate according to the mode information about the inter prediction and the motion information syntax element parsed by the decoder 1510. For example, when the mode information about the inter prediction indicates the merge mode, the motion information determinator 1830 sets a motion vector and a reference picture of a candidate indicated by the merge index information among the merge candidates in the merge list as a motion vector and a reference picture of the current block. On the other hand, when the mode information about the inter prediction indicates the motion vector difference encoding mode, the motion information determinator 1830 determines a motion vector predictor for the motion vector of the current block using the motion vector predictor candidate, and determines the motion vector of the current block by adding the determined motion vector predictor and the motion vector difference parsed from the decoder 1510. Then, a reference picture is determined using the information about the reference picture parsed from the decoder 1510.

The prediction block generator 1840 generate the prediction block of the current block using the motion vector of the current block and the reference picture determined by the motion information determinator 1830. That is, a prediction block for the current block is generated using a block indicated by the motion vector of the current block in the reference picture.

Although exemplary embodiments have been described for illustrative purposes, those skilled in the art will appreciate that and various modifications and changes are possible, without departing from the idea and scope of the embodiments. Exemplary embodiments have been described for the sake of brevity and clarity. Accordingly, one of ordinary skill would understand the scope of the embodiments is not limited by the explicitly described above embodiments but is inclusive of the claims and equivalents thereof.

What is claimed is:

1. A video decoding method for reconstructing one or more pictures from a bitstream, the method comprising:
decoding, from the bitstream, a syntax element for modifying a reference pixel position to be used for predicting a current block in a picture to be decoded;
decoding, from the bitstream, prediction information which includes intra mode information for intra-predicting the current block or motion vector information for inter-predicting the current block; and
determining pixel positions which are referenced for predicting a pixel in the current block using the prediction information, and predicting the pixel in the current block from pixel values of pre-decoded reference pixels corresponding to the determined pixel positions,
wherein, when there is a pixel position outside an image area among the determined pixel positions, the predicting the pixel in the current block comprises:
replacing, using the syntax element, the pixel position outside the image area with a pixel position inside the image area; and
predicting the pixel in the current block using a pixel value corresponding to not the pixel position outside the image area but the pixel position inside the image area.

2. The method of claim 1, further comprising decoding, from the bitstream, a flag indicating whether to allow modifying the reference pixel position to be used for predicting the current block,
wherein the syntax element is decoded only when the flag allows modifying the reference pixel position.

3. The method of claim 1, wherein the flag is decoded from a sequence parameter set or a picture parameter set in the bitstream.

4. The method of claim 1, wherein the syntax element is decoded from a sequence parameter set or a picture parameter set in the bitstream.

5. The method of claim 1, wherein the syntax element includes at least one of a projection format by which a 360 video has projected onto the pictures, an index for each face resulting from the projection, or rotation information about each face.

6. A video decoding apparatus for reconstructing one or more pictures from a bitstream, the apparatus comprising:
a decoder configured to
decode, from the bitstream, a syntax element for modifying a reference pixel position to be used for predicting a current block in a picture to be decoded, and
decode, from the bitstream, prediction information which includes intra mode information for intra-predicting the current block or motion vector information for inter-predicting the current block; and
a predictor configured to determine pixel positions which are referenced for predicting a pixel in the current block using the prediction information, and predict the pixel in the current block from pixel values of pre-decoded reference pixels corresponding to the determined pixel positions,
wherein the predictor is configured to, when there is a pixel position outside an image area among the determined pixel positions,
replace, using the syntax element, the pixel position outside the image area with a pixel position inside the image area, and
predict the pixel in the current block using a pixel value corresponding to not the pixel position outside the image area but the pixel position inside the image area.

7. The apparatus of claim 6, wherein the decoder is configure to decode, from the bitstream, a flag indicating whether to allow modifying the reference pixel position to be used for predicting the current block,
wherein the syntax element is decoded only when the flag allows modifying the reference pixel position.

8. The apparatus of claim 6, wherein the flag is decoded from a sequence parameter set or a picture parameter set in the bitstream.

9. The apparatus of claim 6, wherein the syntax element is decoded from a sequence parameter set or a picture parameter set in the bitstream.

10. The apparatus of claim 6, wherein the syntax element includes at least one of a projection format by which a 360 video has projected onto the pictures, an index for each face resulting from the projection, or rotation information about each face.

11. A video encoding apparatus for encoding one or more pictures, the apparatus comprises:
an encoder configured to
encode, into a bitstream, a syntax element for modifying a reference pixel position to be used for predicting a current block in a picture to be encoded,
encode, into the bitstream, prediction information which includes intra mode information for intra-predicting the current block or motion vector information for inter-predicting the current block, and
encode, into the bitstream, a difference between a pixel in the current pixel and a predicted pixel thereto; and
a predictor configured to determine pixel positions which are referenced for predicting a pixel in the current block using the prediction information, and generate the predicted pixel from pixel values of pre-decoded reference pixels corresponding to the determined pixel positions,
wherein the predictor is configured to, when there is a pixel position outside an image area among the determined pixel positions,
replace, using the syntax element, the pixel position outside the image area with a pixel position inside the image area, and
generate the predicted pixel using a pixel value corresponding to not the pixel position outside the image area but the pixel position inside the image area.

12. The apparatus of claim 11, wherein the encoder is configure to encode, into the bitstream, a flag indicating whether to allow modifying the reference pixel position to be used for predicting the current block,
wherein the syntax element is encoded only when the flag allows modifying the reference pixel position.

13. The apparatus of claim 11, wherein the flag is included in a sequence parameter set or a picture parameter set of the bitstream.

14. The apparatus of claim 11, wherein the syntax element is included in a sequence parameter set or a picture parameter set of the bitstream.

15. The apparatus of claim 11, wherein the syntax element includes at least one of a projection format by which a 360 video has projected onto the pictures, an index for each face resulting from the projection, or rotation information about each face.
